(19) United States
(12) Patent Application Publication
(10) Pub. No.: US 2008/0183580 A1
(43) Pub. Date: Jul. 31, 2008

(54) Method, system and machine-readable media for the generation of electronically mediated performance experiences

(76) Inventor: Michael G. Horne, Santa Cruz, CA (US)

Correspondence Address: PATRICK REILLY, P.O. BOX 7218, SANTA CRUZ, CA, 95061-7218, US

(21) Appl. No.: 12/009,604

(22) Filed: Jan. 17, 2008

Related U.S. Application Data
(60) Provisional application No. 60/881,332, filed on Jan. 18, 2007.

(51) Int. Cl. G06Q 30/00; G06Q 20/00; G06Q 10/00

(52) U.S. Cl. 705/14; 705/39; 705/26; 705/400

(57) ABSTRACT

A method, system and machine-readable media that support the generation of electronically mediated performances are provided. In one version, a digitized audio and video record of a live performance by a musical artist may be transmitted via the Internet or other electronics communications network to one or more remote venue. At each participating venue the record is rendered to provide a performance experience. The record may optionally be downloaded to a computational system that remains the property of a third party and the intellectual property rights of the record are retained by the artist or as assigned by the artist. One or more venues may include digital recording equipment that generates a video and/or audio record of activity at the venue during the rendering of the performance. This record may be used to verify audience size estimation and revenue obligations of a venue operator or event producer.

### CROSS-REFERENCE TO CO-PENDING PATENT APPLICATION

This application claims the benefit of U.S. Provisional Application No. 60/881,332, filed Jan. 18, 2007, which application is incorporated herein by reference in its entirety and for all purposes.

### BACKGROUND OF THE INVENTION

Multimedia technologies, such as radio, and television, have made multiple advances for the transmission of live or rebroadcast events. Indeed, conventional techniques of digital media capture and distribution are being applied to generate various ways to exploit and distribute intellectual property rights in the entertainment and digital content management industries (see, e.g., U.S. Pat. Nos. 7,099,849 and 6,924,425; U.S. patent application Ser. Nos. 11/103,696; 11/128,757; 10/159,344; and 10/092,498). Yet these advances have failed to define or show techniques to enable wider presentation of live performances, or performances that include digitized recordings of live performances, in multiple venues while optimally preserving the intellectual property rights of one or more performing artists.

Additionally, it has been difficult to recreate an environment outside of the geographical location of the event which mimics attendance at the event itself. Despite advances in television performance and picture quality, viewing a concert or political speech in ones home does not recreate the atmosphere present in the live venue because a component of the atmosphere at such events is the communal shared experience. A similar problem exists with internet broadcasts and access to recorded performances. Additionally, placing a performance or recording for access on the internet cannot maximally protect the intellectual property rights of the performer. Thus, methods and systems which allow for wide distribution of performances, recreation of the atmosphere of a live event, and protection of the intellectual property rights of performers are desirable.

The present invention discloses systems and methods of delivering performances, such as concerts, plays, and speeches, to widely geographically dispersed venues. Additionally, the present invention discloses methods of protecting the intellectual property rights of performers and allowing the performers to collect higher revenues by distributing live and/or recorded digitally recordings of their performances and charging attendees at remote venues for admission to the replaying of the performance at the remote venues.

### SUMMARY OF THE INVENTION

In one embodiment, the present invention provides a method of preserving artists' intellectual property rights while enabling live performances to be presented to wider audiences than those who can personally attend that performance. This method, in part, comprises the steps of: a) recording the live performance; b) converting the recorded performance to digitized data; c) transmitting the data to remote venues other than the site of the live or pre-recorded performance; d) converting the digitized data to perceivable images and/or sounds; e) projecting the images and/or sounds at a remote venue (e.g., nightclubs, theaters, performance halls and college campuses); and f) creation of a monetization model for the end user.

In a related embodiment, the digitized data is transmitted to members of a national and/or international subscriber network, organized by the producing agent. The transmission of the digitized data can be via any method known in the art, e.g. the Internet, an intranet, an extranet, a telephone system, an Earth orbiting satellite system, a wireless communication system, a DVD, an optical disc, a CD, and/or other computer-readable media. The network subscribers will typically be provided with a “remote venue system” containing materials and devices which allow the individual subscriber to convert the digitized data, project images and/or sounds, screen the performance and promote the performance. The network subscribers may be subscribers for a single performance and/or event or for multiple performances and/or events.

In some embodiments, the digitized data can be transmitted, converted and projected at remote venues substantially simultaneously or following with the live performance. In such embodiments, the performance can be captured by the producing agent's personnel, personnel hired by the artist, performer, or their agent(s), and/or other authorized personnel. Additionally, the digitized data may be routed through a central facility prior to distribution to remote venues. In other embodiments, the digitized data can be stored in or on a suitable storage medium. In still other embodiments, the digitized data is both transmitted to remote venues and stored on a suitable medium. In still another embodiment, the digitized data is transmitted to at least one remote venue, stored locally at the remote venue, and then converted and projected at the remote venue at a later time, for example 24 hours or twelve months after the live performance. In still another embodiment, the digitized data is stored in an archive for longer periods of time. Such archived data can be distributed upon request of at least one remote venue. Such archived data can also be destroyed at the request of the artist, performer, and/or their agent(s).

In another related embodiment, the producing agent represents the performers (e.g., artists) and/or the performers' management directly, authorizing the legal distribution of, and ability to resell, the recording of the live performance. This can be achieved by direct interaction between the producing agent and the artists, management, and/or licensing authorities. To prevent piracy and other depletion of the artist's or performer's intellectual property rights, the record of the live performance is typically not available to non-network-subscribers. Furthermore, in many embodiments, the record of the live performance is available to network subscribers for a single download and play for a limited amount of time, e.g. 24 hours or seven days. In some embodiments, such control over network subscribers' access to recorded data is achieved through contract between the subscriber and the producing agent, software and other technology incorporated into the “remote venue system,” and/or other techniques.

In another embodiment, compensation for the artist or performer may be a flat fee. In still another embodiment of the present invention, compensation for the artist or performer is calculated based on the number of attendees at remote venues. In some embodiments, the number of attendees at a remote venue will be calculated based on actual counts, ticket sales, or other direct counting methods well known in the art. In other embodiments, analysis of images taken at remote venues can be used to estimate the amount of compensation the artist will receive. Such estimates based on images can be computed by any method known, e.g. crowd number estimation equations and computer-based image analysis. For these embodiments, the producing agent may monitor and collect revenue from every attendee at every venue and remit a predetermined portion of the proceeds to the artist, performer, and/or their agent(s).

Additionally, the producing agent may represent, identify and collect revenues on behalf of licensing authorities such as The American Society of Composers, Authors and Publishers (ASCAP), Broadcast Music, Inc. (BMI), and The Society of European Stage Authors & Composers (SESAC). In some embodiments, the presenting remote venue will retain a predetermined percentage of the gross box office receipts for that venue, e.g. 20%, 25%, 30%, 35%, 40%, 45%, 50% or more. The producing agent may collect the remaining percentage of the gross box office receipts from each remote venue and distribute a percentage of those receipts to the artist, performer, and/or their agent(s), e.g. 20%, 25%, 30%, 35%, 40%, 45%, 50% or more of the receipts. In other embodiments, the producing agent may charge a flat viewing fee.

In still further related embodiments, images and sounds from one or more remote venues may be recorded and transmitted as digitized data to other remote venues. Such embodiments allow for a greater sense of community at remote venues, especially smaller remote venues. Current techniques such as podcasts and streaming video to individual computers does not allow for this communal experience. Such images and sounds will be recorded and transmitted in a similar manner to the recording and transmitting of the live performance. Typically, digitized data encoding images and/or sounds of attendees at remote venues will not be stored locally for a lengthy amount of time, e.g. immediately, or less than 72 hours following delivery. Digitized data may be stored or archived at a central facility for longer than 72 hours.

In still further related embodiments, promotional materials may be provided to remote venues by: 1) the producing agent; 2) individual promoters, typically local to the site of the remote venue; 3) artists, performers, or their agent(s); 4) record labels (e.g., the record label which produces the performers' albums, CDs, etc.); 5) grass-roots promoters; 6) or a combination of these. In still further related embodiments, some portion of the proceeds from remote venues may be donated to charities, social causes, political action committees, and/or other interests based on the attendee's choice, the remote venue's choice, the artist's choice, the producing agent's choice, or a combination of any or all of these.

Towards these objects, one embodiment of the method of the present invention provides a system for rendering digitized records of a performance, wherein the system is communicatively coupled with an electronic communications network (hereafter “network”) and a set of rendering equipment. The rendering equipment may be configured to render digitized audio and video data and may include a communications interface, and a memory and a central processing unit (hereafter “CPU”). The communications interface may be communicatively coupled with the network and configured to receive digitized data from the network. The memory configured to store the digitized data received from the network. The CPU is communicatively coupled with the rendering equipment, the communications interface and the memory, and is configured to provide or enable transmission of the digitized data from the memory to the rendering equipment and to erase the digitized data after a rendering of the digitized data by the rendering equipment.

In an alternate preferred embodiment of the method, the digitized data may include representations of a live musical performance and be erased within a set time, e.g., about 24 hours, about 36 hours, about 48 hours, about 56 hours, about 72 hours, or even more, after a playback of the source performance.

In other preferred embodiments of the method of the present invention, the network may be the Internet, an Intranet, an Extranet, a telephony system, an Earth orbiting satellite system, and/or a wireless communications system.

The system optionally comprises a video module, wherein the video module produces a digitized image of activity occurring proximate to the rendering equipment during the rendering of the digitized data. The video module may alternatively or additionally be communicatively coupled with the network and/or an electronic media record.

In still alternate preferred embodiments of the present invention, the CPU is communicatively coupled with an electronic media recorder, and digitized data received from the network may be recorded on the electronic media record, whereby a mix of digitized images of the performance and of the activity proximate to the rendering equipment may be recorded on the electronic media record.

The system may optionally include an electronic media reader configured to receive the digitized data from a computer-readable media, e.g., a CD, DVD and/or optical disk.

A yet alternate preferred embodiment of the method of the present invention includes the elements of (a.) transmitting a digitized image of a performance via an electronics communications network; (b.) rendering the digitized image by means of electronic computational system and rendering equipment at a plurality of venues; and (c.) erasing the digitized image at each electronic computational system and rendering equipment after rendering. The rendering at each venue of a plurality of venues may occur substantially simultaneously.

In yet other alternate preferred embodiments of the method of the present invention, a producing agent secures intellectual property rights to transmit and render the digitized image, and/or an artistic agent retains or assigns all remaining intellectual property rights of the performance held by the artistic agent. The artistic agent may optionally be a participating artist of the performance.

In certain additional alternate preferred embodiments of the method of the present invention, the method includes: a) generating a digitized venue record of activity occurring at least one venue; b) analyzing the digitized venue record to determine audience size at least one venue; c) mixing the digitized image of the performance with the digitized venue record; d) encoding visual signage into the digitized image and rendering of the visible signage with the digitized image; and/or e) recording the digitized image onto a master computer-readable media and assigning the producing agent with rights to physically possess the master computer-readable media.

Yet another alternate preferred embodiment of the present invention provides a computer-readable media comprising machine-readable instructions for directing a computational system to execute one or more of the aspects of the method of the present invention.

Certain other additional alternate preferred embodiments of the method of the present invention provides system for rendering digitized data, the system communicatively coupled with at least one digitized data source and with digitized data rendering equipment, the system comprising: a data interface a memory and a CPU, wherein the CPU is communicatively coupled with the digitized data rendering equipment, the data interface and the memory, and the CPU is configured to control transmission of the digitized data from at least one digitized data source to the memory and from the memory to the digitized data rendering equipment and from the memory to at least one digitized data source and then to erase the digitized data from the memory after completion of data transfer. The digitized data may alternatively or additionally represent and/or present an audio and visual record of a performance. The digitized data source may be a wired or wireless data network. The digitized data source may alternatively or additionally include or be a readable and/or writeable medium and/or a local audio/visual capture module. The digitized data rendering equipment may alternatively or additionally be configured to render audio and visual data.

Certain other alternate preferred embodiments of the method of the present invention enable producing performance experiences at numerous venues, the method comprising: 1) transmitting a digitized image of a performance via an electronics communications network or via a digital data medium; 2) rendering the digitized image by means of electronic computational system and rendering equipment at a plurality of venues; and 3) erasing the digitized image at each electronic computational system and rendering equipment after rendering.

A system for enabling the method of the present invention may include means for rendering digitized audio and visual data, wherein the system is communicatively coupled with at least one digitized data source and with digitized audio and visual data rendering equipment. The enabling system may include a data interface, a memory, and a CPU, wherein the CPU is communicatively coupled with the digitized audio and visual data rendering equipment, the data interface and the memory, and the CPU is configured to control transmission of the digitized audio and visual data between at least one digitized data source and the memory and between the memory and the digitized audio and visual data rendering equipment and then to erase the digitized data from the memory after completion of data transfer.

The foregoing and other objects, features and advantages will be apparent from the following description of the preferred embodiment of the invention as illustrated in the accompanying drawings.

### INCORPORATION BY REFERENCE

All publications, patents, and patent applications mentioned in this specification are herein incorporated by reference to the same extent as if each individual publication, patent, or patent application was specifically and individually indicated to be incorporated by reference. U.S. Pat. Nos. 7,099,849; 6,937,259; and 6,924,425; and U.S. patent application Ser. Nos. 11/103,696; 11/128,757; 10/938,125; 10/159,344; and 10/092,498; and PCT application WO2000/14961 are incorporated herein by reference and for all purposes.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 illustrates a communications network coupled with a performance site, a video processing system, and a plurality of venue systems.

FIG. 2 is a schematic diagram of the performance site, or performance venue site, of FIG. 1.

FIG. 3 is a schematic diagram of the video processing system of FIG. 1.

FIG. 4 is a schematic diagram of one of the venue systems of FIG. 1.

FIG. 5 is a process chart of a first alternate preferred method of the present invention that may be implemented by means of the communications network the performance site, the video processing system, and the plurality of venue systems of FIG. 1.

FIG. 6 is a process chart of a second alternate preferred method of the present invention that may be implemented by means of the communications network the performance site, the video processing system, and the plurality of venue systems of FIG. 1.

FIG. 7 is a chart showing the interaction between the producing agent and various entities.

### DETAILED DESCRIPTION OF THE INVENTION

In describing the preferred embodiments, certain terminology will be utilized for the sake of clarity. Such terminology is intended to encompass the recited embodiment, as well as all technical equivalents, which operate in a similar manner for a similar purpose to achieve a similar result.

The present invention discloses methods, systems, and machine-readable media for reproducing live and/or recorded events (e.g., concerts, speeches, sporting events, plays) in multiple venues, typically remote from the location where the event occurs. These methods include digitally capturing audio and video of the event or performance and transmitting the digital data encoding the performance to a central processing facility. In instances where the event is simulcast to multiple locations, the data may freely stream to remote venues. In instances where the event is broadcast at a later time, the data is stored at the central facility and then distributed along a network to the remote venue. In most instances, the remote venues will be members of a subscribing network (i.e., the venues pay for the right of access to the performances). Data sent to the venues is typically sent to proprietary rendering equipment which is leased by the venues. Such rendering equipment may allow for production of the images and/or sounds of the performances. In some instances, the rendering equipment will store the data comprising the performance locally at the venue for a set amount of time, but will eventually be erased from the rendering equipment. These aspects assure that the intellectual property rights of the performer (e.g. distribution and reproduction rights) are not depleted.

Furthermore, the reproduction of the performances at the remote venues may be advertised in advance of producing the recorded performance at the venue. In some instances, tickets may be sold to attendees at the remote performances. In other instances, flat fees (e.g., cover charge) may be charged. In such instances, the performers, the venue, the licensing agent, and the producing agent may take portions of the ticket sales and/or flat fees. This system also benefits persons in rural areas or cities where live performances by particular artists are not scheduled, both by making the performances available to these groups and lowering the amount of travel necessary to attend a live performance.

In some embodiments, the digitized data encoding the performance will be rendered at a venue large enough to accommodate a crowd of people, which may mimic attendance at a live performance. In other embodiments, video may be captured from remote venues, transmitted to a central facility and then sent to other venues which may be showing the performance at the same time. Thus, connecting some number of the multiple venues allows for an expansion of the number of persons who participate in the shared experience. By recreating an atmosphere reminiscent of a live venue, the present invention provides a distinct experience to persons attending a rendered concert. Such interaction with people at the same venue, people at other venues, and/or people at the live event provides a different experience of the event than individual viewing and/or viewing in small private groups (e.g., pay-per-view, watching a concert clip on YouTube.com, watching a DVD of a recorded concert at home).

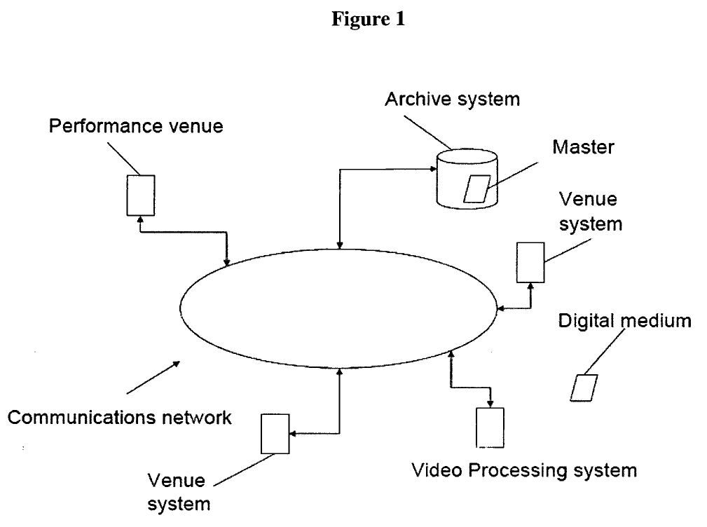

FIG. 1 illustrates a communications network coupled with a performance site, a video processing system, a content storage system and a plurality of venue systems. The communications network (hereafter “network”) may be, or comprise: 1) the Internet; 2) an Intranet; 3) an Extranet; 4) a telephony system; 5) an Earth orbiting satellite system; and/or 6) a wireless communications system. Digitized video and audio data may be transmitted via the network to and from the performance site, the video processing system, the content storage system, and one or more venue systems. Digitized video and audio data may alternatively or additionally be communicated and/or transmitted to and from the performance site, the video processing system, the content storage system, and/or one or more venue systems by means of a computer-readable digital medium, e.g., a compact disk, an optical disk, or a DVD.

According to a certain alternate preferred embodiments of the method of the present invention, a producing agent may secure intellectual property rights to transmit and render the digitized information generated at, or provided from, the performance site, and an artistic agent may retain or assign some or all remaining intellectual property rights of the performance-related digitized information. The artistic agent may be a participating artist of the performance.

The terms “computer-readable medium” and “computer-readable media” as used herein refer to any suitable medium known in the art that participates in providing instructions or information to a network and/or a computer for execution or storage. Such a medium may take many forms, including but not limited to, non-volatile media, volatile media, and transmission media. Non-volatile media includes, for example, optical or magnetic disks, such as may be comprised within a computer system memory.

Volatile media includes dynamic memory; transmission media includes coaxial cables, copper wire and fiber optics. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer system can read machine-executable instructions and/or data.

Various forms of computer readable media may be involved in carrying one or more sequences of one or more instructions to the network for execution. For example, the instructions may initially be carried on a magnetic disk of a remote server. The remote server can load the instructions into its dynamic memory and send the instructions over a telephone line using a modem. A modem local to or communicatively linked with the network can receive the data on the telephone line and use an infra-red transmitter to convert the data to an infra-red signal. An infrared detector can receive the data carried in the infrared signal and appropriate circuitry can provide the data to the network.

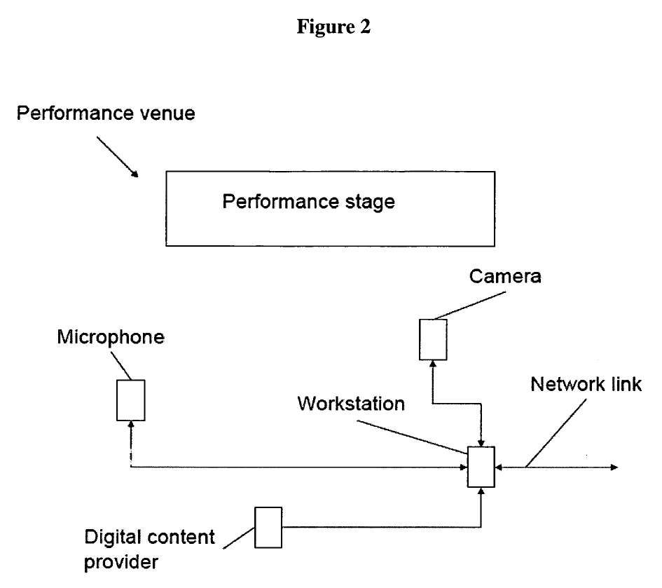

FIG. 2 is a schematic diagram of the performance site of FIG. 1. A workstation is communicatively coupled with a digital camera and a digital microphone to create a record of a performance or event, such as a poetry reading, a speech or a live musical performance as presented on a performance stage. One of skill in the art will recognize that multiple cameras and microphones will be appropriate for recording the performance or event. The workstation may include a digital media read/write and transfer the digital information received from the camera and microphone to a computer readable medium, such as a DVD. The workstation may be, but is not limited to, an APPLE POWERBOOK™ personal computer, or other suitable personal computer, computer workstation, or computational device known in the art. Alternatively or additionally, the workstation may transmit the digital information received from the digital camera and the digital microphone to the video processing system, the content storage system, and one or more venue systems by means of the network and via a network link.

Additional digital content may be inserted or appended to the digital information generated by the camera and the microphone. This additional digital content may be or include textual information, commercial advertisements, enhancement effects, legal or contractual stipulations, background information, instructions, or other suitable information known in the art.

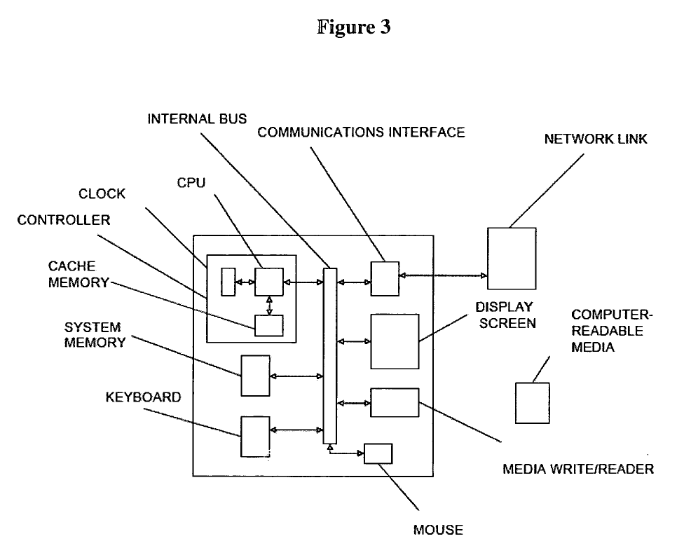

FIG. 3 is a schematic diagram of the video processing system of FIG. 1. The video processing system may be, but is not limited to, an APPLE POWERBOOK™ personal computer, or other suitable personal computer, computer workstation, or computational device known in the art, and includes a CPU, a network interface circuit and a digital media read/write device. The video processing system may receive digital information generated by or transmitted from the performance site by means of the network and the network interface circuit, and/or the digital media read/write device and a computer-readable digital media.

The video processing system may optionally receive, via the network and/or the digital medium, additional digital content for inclusion into or appendage with the digital information received from the performance site. The video processing system may be an APPLE POWERBOOK™ personal computer, or other suitable personal computer, computer workstation, or computational device known in the art.

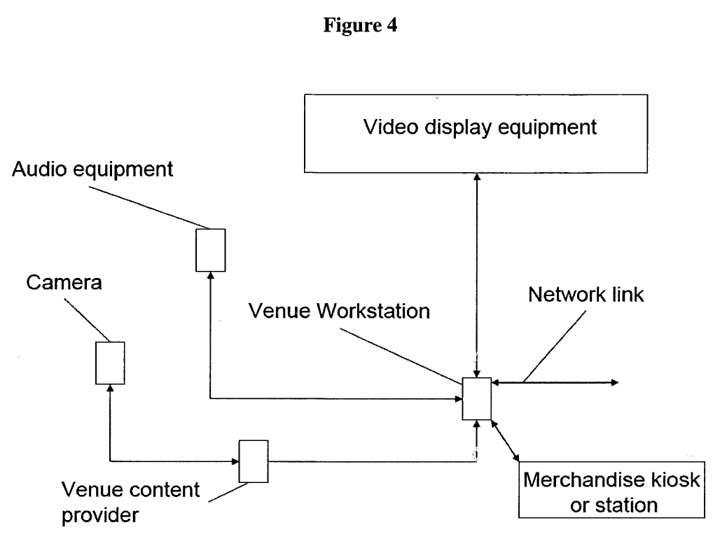

FIG. 4 is a schematic diagram of one of the venue systems of FIG. 1. The venue system includes a venue workstation, an optional digital camera and an optional venue content provider. The venue system is communicatively coupled with a digital data rendering equipment, wherein the rendering equipment includes video display equipment and audio equipment. The video display equipment may be configured to provide a near full-scale, life size two visual image or a three-dimensional hologram rendered from the digital information received from the venue workstation.

Also shown in FIG. 4 is a merchandise kiosk or workstation. Such point of sale merchandise stations may be of any sort known in the art, including, but not limited to, personnel-manned kiosks and electronic kiosks. In some embodiments, an electronic kiosk is not communicatively coupled with the venue system, but is a stand-alone unit. In other embodiments, an electronic kiosk is communicatively coupled with the venue system. In all embodiments, an electronic kiosk may be portable, wall-mounted or free-standing. Many such electronic kiosks are commercially available (e.g., BuyPoint™, Friendlyway™, SeePoint™) and may utilize commercially available software (e.g., iPoint Beta Version™, FireCast OS™).

Any system compatible with the venue system may be used in embodiments in which the kiosk and the venue system are communicatively coupled. Electronic kiosks may include features such as, but not limited to, flat-screen technology, credit card swipable portals, touch screen capability, keyboard entry, product search features, and advertising. Additionally, kiosks customized to a particular venue, a particular performer, or other identifiers may be utilized in some embodiments.

Point of sale merchandise workstations or kiosks typically allow attendees at a venue to purchase products related to the performance which is being attended. Such products include, but are not limited to, DVDs comprising a recorded performance, CDs, computer-readable files (e.g., MP3, downloadable files), clothing (e.g., t-shirts, hats), accessories (e.g., wrist bands, bags, frisbees), and other paraphernalia (e.g., posters, glow sticks). In some embodiments, the products offered for sale are related to the performance being rendered at the venue (e.g., t-shirts depicting the performing artist or group). In other embodiments, kiosks may provide information about the venue, future performances and/or ticket sales. Electronic and/or personnel-manned kiosks may directly dispense products to purchasers, or may provide for delivery of ordered products to other locations (e.g. home address, email address, workplace). The ability to buy merchandise related to the performer and/or performance may further enhance the live-event attendance atmosphere created by the invention disclosed herein.

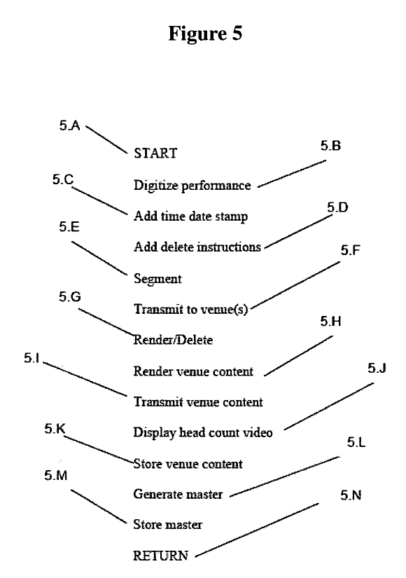

FIG. 5 is a process chart of a first alternate preferred method of the present invention that may be implemented by means of the communications network the performance site, the video processing system, and the plurality of venue systems of FIG. 1.

In step 5.B, the performance site workstation at the performance site generates a digitized record of a live performance or event. In step 5.C, a time date stamp related to the time of the performance is added to the digitized record. In 5.D, delete instructions to be enforced in storing or rendering the digitized record is added to the digitized record, e.g., instructions to delete the record within 72 hours of the conclusion of the start or end of the source live performance. In step 5.E, the digitized record may be segmented for streaming, or to conform to one or more communications standards, or to optimize transmission efficiency or speed. In step 5.F, transmission of the digitized record to one or more venues is initiated. The transmission of step 5.F may be accomplished by means of the network and/or a DVD or other suitable computer-readable medium or media. In step 5.G, the digitized record is rendered and optionally deleted by the venue workstation. In step 5.H, venue digital content generated at the venue, or provided to the venue outside of the digitized performance record of step 5.F, is rendered. The venue digital content may be digital information captured by the venue digital camera and/or the venue digital content provider. Venue digital content provided by the venue digital camera may include visual images of participants at a venue, wherein the visual images of participants at the venue may be useful in counting or estimating the size of audience present at the rendering of step 5.G.

Optionally, a producing agent may secure or possess intellectual property rights to transmit and render the digital information generated at the performance site, and an artistic agent may retain or assign some or all remaining intellectual property rights of the performance held by the artistic agent. The artistic agent may be a participating artist of the performance.

In step 5.I, the digital content generated at the venue is provided to the video processing system and/or the storage system, and/or recorded onto a DVD or other suitable computer-readable medium. In step 5.J, the images of the participants present during the rendering of step 5.G is displayed to determine or estimate the audience size present at the venue during the execution of step 5.G. In step 5.K, the venue content is stored at the video processing system and/or the video processing system. In step 5.L, the video processing system is used to generate a master record of the performance digital information optionally mixed with the venue content of step 5.H. In step 5.M, the master record generated in step 5.L is stored in the video processing system and/or the storage system.

It is understood that in certain alternate preferred embodiments of the method of the present invention the video storage system and the storage system be integrated together into a single system.

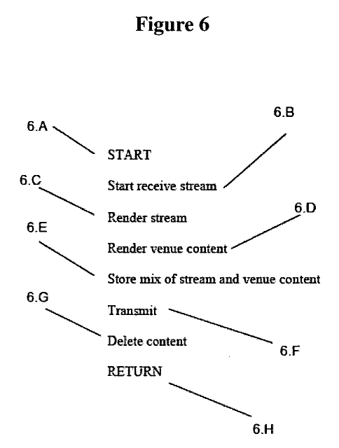

FIG. 6 shows a process chart of a second alternate preferred method of the present invention that may be implemented by means of the communications network the performance site, the video processing system, and the plurality of venue systems of FIG. 1. In step 6.B, the venue system begins to receive a digital content stream substantially sourced from the performance venue from the network, or alternatively receive digital content from a DVD or other suitable digital media known in the art. In step 6.C, the digital content received in step 6.B is transmitted from the venue system to, and rendered by, the rendering equipment at the venue. In step 6.D, digital content received by the venue system outside of the performance content received in step 6.B is transmitted to, and rendered by, the rendering equipment at the venue. In step 6.E, some or all of the digital information rendered in steps 6.B, 6.C and/or 6.D is mixed and/or stored in a system memory or cache memory of the venue system. In step 6.F, the digital information stored in step 6.E is transmitted via the network and/or stored on a DVD or other suitable digital media. In step 6.G, the digital information received in step 6.B and/or stored in step 6.E is deleted from the venue system.

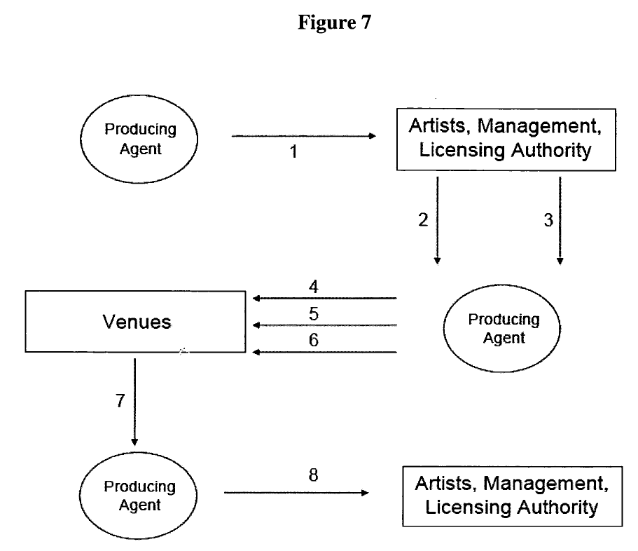

An additional embodiment of the present invention is depicted in FIG. 7. FIG. 7 shows the interaction between the producing agent and various entities. Step (1): A producing agent contacts and represents artists or performers with respect to recording and broadcasting a live performance to a network of subscribers. It is understood that the producing agent may also contact and represent the performer's agents, management, or others who have the ability to negotiate on behalf of the artist or performer. In some instances, the artist will choose the date or dates of the performance or performances to be recorded. As used herein, the terms “artist” and “performer” are used interchangeably.

Step (2): The producing agent secures the intellectual property rights (e.g., to record a live performance, distribute the recordings, produce and/or reproduce the performance) by the right holder. The right holder may be the artist, an agent, or any other entity in which intellectual property rights to the performance and/or recordings are vested. Alternately, the producing agent may secure the rights to a pre-recorded performance. Typically, a live performance is recorded by camera crews and/or automated equipment employed by the producing agent. The images and/or sounds can be recorded digitally, or recorded using a non-digital medium (e.g. film) and converted to digitized data and transmitted via an appropriate system (e.g. the Internet) to a central facility. In some instances, the recording may be conveyed to a central facility prior to conversion to digitized data.

In some embodiments, the digitized data is transmitted to remote venues at substantially the same time as the live performance (e.g., live streaming video). In other instances, the digitized data representing the live performance is recorded. In instances where a performance is recorded, digitized data representing the performance may be transmitted to venues 1, 2, 3, 4, 5, 6, 7, 8, 9, 10, 11, 12, 13, 14, 15, 16, 17, 18, 19, 20, 21, 22, 23, 24 or more hours after the performance was recorded. In other instances, digitized data representing the performance may be transmitted to venues 1, 2, 3, 4, 5, 6, 7, 8, 9, 10, 20, 30, 40, 50, 60, 70, 80, 90, 100, 200, 300 or more days after the performance was recorded. In still other instances, digitized data representing the performance may be transmitted to venues 1, 2, 3, 4, 5, 6, 7, 8, 9, 10, 20, 30, 40, 50, 60, 70, 80, 90, 100 or more years after the performance was recorded. The digitized data may be stored, modified, and/or combined with other information and/or images before broadcast to other venues as described below. In most instances the recorded images will be branded with the producing agent's mark and/or a watermark prior to broadcast. In other instances, advertisements may be added to the digitized data. In some instances, images of attendees at one or more venues are added to the digitized data.

Step (3): The producing agent secures the rights to distribute and/or resell the recording to one or more remote venues. In some instances, the recording will be simultaneously or substantially simultaneously broadcast to the participating venues on a one-time basis. Additionally, a recorded performance may be archived or stored, typically in a central facility. At the request of the artist and/or management, the recording may be archived for future broadcasts. Typically, the artist, management and/or licensing authority will retain the intellectual property rights to the recorded images and/or sounds.

Protection of intellectual property rights is achieved through several mechanisms. Typically, the recorded performances are transmitted from a central facility only to participating venues. The recorded performance is encoded and prepared for broadcast at the central facility and then distributed to network subscribers via a closed content distribution network (CDN). The CDN may be accessible via larger communications media (e.g., the Internet, an intranet, an extranet) and as such, any computer or other interface which can interact through the communications media may be considered a subserver on the CDN. In other instances, access to the CDN will be via a unique access vehicle (e.g, PIN number, account number, password).

In some instances, the data will be encrypted. The broadcast is stored locally at the participating venue in the rending equipment, but is otherwise inaccessible. Typically, the broadcast will be available to participating venues for only 72 hours. The length of time the digitized data is stored in the rending equipment, encryption and the transmission of the data over a CDN serve to prevent any attendees from pirating the signal and digitized data. The artist and/or management will typically retain the right to archive, delete, or otherwise control any future broadcast of the recorded and branded performance.

In addition to representing the artists with respect to the broadcast, the producing agent is allied with multiple venues which will receive the broadcast, e.g. nightclubs, theaters, and college campuses. These venues are network subscribers of the distribution network organized by the producing agent.

Step (4): Each venue is outfitted with projection screens, digital light projectors, broadband capability, and rendering equipment (e.g., ClubLync™ video and audio data rendering equipment, or other suitable rendering equipment comprising a central processing unit, an Internet Protocol Television equipment, a cable television or Internet-coupled set-top box, and/or a digital video disc rendering system) capable of receiving and rendering digitally recorded images and/or sounds provided by the producing agent. In some instances, projection screens, broadband capability and digital light projectors may be owned by the individual venue. In most instances, the network subscribers will receive the rendering equipment from the producing agent. Additionally, the rendering equipment will typically be either directly or indirectly connected to the CDN used by the producing agent to transmit the digitized data. The venues pay a fee to the producing agent for equipment provided by the producing agent. This fee may be paid monthly, quarterly, or yearly. Rendering equipment may also be provided by a producing agent on a per use basis. In some instances, the rendering equipment may be pre-loaded with the selected performance.

Step (5): The producing agent provides a selection of recorded performances which are made available to participating venues. Typically, the venues choose which performances will be rendered at that venue. The producing agent may provide promotional materials for the selected performances, as well as promotional materials for other broadcasts. In addition, the producing agent may elect to liaison with record labels and other businesses to merchandise sales opportunities at or near the venues. The venues may elect to provide sellers and accounting of any sales of such merchandise at the venue.

A broadcast selected by the participating venue is sent from the central facility. Step (6): The broadcast is received by the rendering equipment provided by the producing agent. Typically, the broadcast will be rendered at the participating venue within 72 hours of receipt from the central facility. The venue(s) render the images and/or sounds of the performance using the rendering equipment supplied by the producing agent.

In all instances, the broadcast is removed from the memory of the rendering hardware at the participating venues. Typically, this removal occurs within 72 hours. In some instances, the broadcast is removed upon completion of rendering the recorded performance. At each venue, revenues are typically collected from attendees of the rendered performances through various means, for example, ticket sales, cover charges, or any other method known in the art. In some instances, the producing agent may sell tickets directly to attendees at any venue. In other instances, tickets may be sold to attendees through a third party, (e.g. Ticketmaster™). The producing agent or third party may charge a service fee for such sales. In instances where the producing agent or third party sells tickets to attendees, the proceeds will be remitted to the producing agent. In other instances, the producing agent will confer a contractually agreed upon percentage of the ticket sales to the venue, the performer and/or a licensing authority. In some instances, a venue will pay a flat rate for rendering the broadcast, independent of the number of attendees. In other embodiments, (e.g., college campus venues, community event venues), the concert may be sponsored such that a flat rate is paid to the producing agent by the sponsor. Typically in sponsor embodiments, individual attendees will not pay for admittance to the performance. In any or all of these embodiments, point of sale merchandise stations and/or kiosks may be present at the remote venues.

Step (7): In most instances, the venues remit a portion of the proceeds from the display of the broadcast to the producing agent. In other instances the venues remit a flat-rate fee. Step (8): The producing agent then remits a portion of the proceeds or flat-rate fee to the artist, management and/or licensing authority. For example, the presenting venue may keep 45% of the gross box office receipts. The producing agent collects the remaining 55% and distributes 5% to a licensing authority, 25% to the artist and retains 25%. Thus, where presenting venue sells 100 tickets at 10 dollars each, the venue keeps 450 dollars, the licensing authority receives 50 dollars, the artist receives 250 dollars, and the producing agent receives 250 dollars.

The foregoing disclosures and statements are illustrative only of the present invention, and are not intended to limit or define the scope of the present invention. The above description is intended to be illustrative, and not restrictive. Although the examples given include many specifics, they are intended as illustrative of only certain possible embodiments of the present invention. The examples given should only be interpreted as illustrations of some of the preferred embodiments of the present invention, and the full scope of the present invention should be determined by the appended claims and their legal equivalents. Those skilled in the art will appreciate that various adaptations and modifications of the examples provided by the preferred embodiments can be configured without departing from the scope and spirit of the present invention. Therefore, it is to be understood that the present invention may be practiced other than as specifically described herein. The scope of the present invention as disclosed and claimed should, therefore, be determined with reference to the knowledge of one skilled in the art and in light of the disclosures presented above.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A method of distributing performances, comprising:
(a) securing from a right-holder rights comprising recording rights, distribution rights, any use right, or a combination thereof;
(b) licensing rendering equipment connected to a network of one or more venues, wherein said rendering equipment is capable of displaying said performances;
(c) distributing said performances to at least one venue connected to said network; and
(d) compensating said right holder for each rendering.

2. The method of claim 1, wherein said one or more venues can select individual performances from a menu of recorded performances.

3. The method of claim 1, further comprising collecting compensation for a licensing authority.

4. The method of claim 1, wherein said network is a closed content distribution network.

5. The method of claim 1, wherein digitized data corresponding to said performance is stored in said rendering equipment for less than 100 hours.

6. The method of claim 1, wherein access to said performance by said at least one venue is limited to a predetermined amount of time following recording said performance.

7. The method of claim 1, wherein a portion of said compensation is determined by recording images of attendees in at least one of said plurality of venues during a rendering, estimating the number of said attendees, and collecting a fee from said at least one of said plurality of venues corresponding to said estimation.

8. The method of claim 1, further comprising removing digitized data corresponding to said performances from said rendering equipment after rendering or after a predetermined period of time.

9. A method of presenting performances to an audience comprising:
(a) obtaining from a right holder rights comprising recording rights, distribution rights, any use rights, or a combination thereof;
(b) conveying digitized data representing a live performance to rendering equipment in at least one venue;
(c) storing said digitized data in said rendering equipment for up to a specified time.
(d) rendering said digitized data at said venue;
(e) collecting a fee for said rendering.

10. The method of claim 9, wherein said digitized data is conveyed to a central facility prior to being conveyed to said rendering equipment.

11. The method of claim 9, further comprising recording at least one live performance by a performer and converting said recording to digitized data.

12. The method of claim 11, wherein said performance is recorded by personnel hired by a producing agent.

13. The method of claim 9, wherein said at least one venue comprises a plurality of venues.

14. The method of claim 9, wherein said fee is generated by tickets sold to attendees or a cover charge collected from attendees at said venue.

15. The method of claim 14, wherein said ticket sales take place through a venue, through a producing agent, through a third party, or a combination thereof.

16. The method of claim 9, wherein said fee is a flat-rate paid by said venue.

17. The method of claim 9, wherein said venue contributes collected fees to total revenues based on the number of attendees at said rendered performance.

18. The method of claim 17, wherein a portion of said total revenues is divided between the right holder, the producing agent and a licensing authority.

19. The method of claim 9, wherein said venue pays a fee for said rendering equipment.

20. The method of claim 19, wherein said fee for said rendering equipment is paid monthly.

21. The method of claim 9, wherein said digitized data is conveyed via the Internet, an intranet, an extranet, a telephony system, an Earth orbiting satellite system, a wireless communication system, a DVD, an optical disc, a CD, a computer-readable medium, or a combination thereof.

22. The method of claim 9, wherein said digitized data is modified at a central facility and is optionally encrypted.

23. The method of claim 22, wherein said modification comprises the addition of information consisting of a brand, a watermark, or a combination thereof.

24. The method of claim 22, wherein said modification comprises the addition of images recorded at said at least one venue.

25. The method of claim 9, wherein said digitized data is removed from said rendering equipment within 72 hours.

26. The method of claim 9, further comprising storing said digitized data at a site other than said rendering equipment.

27. The method of claim 26, wherein said stored digitized data is transmitted to at least one venue more than three hours after said live performance.

28. The method of claim 9, wherein said digitized data is transmitted to said rendering equipment within three hours of said live performance.

29. The method of claim 9, further comprising obtaining the right to resell said digitized data of at least one live performance.

30. The method of claim 9, wherein said venue is a network subscriber.

31. The method of claim 9, further comprising providing said at least one venue with promotional materials prior to said rendering.

32. The method of claim 31, wherein said promotional materials are provided by one of a group consisting of a producing agent, an event promoter, said right holder, said right holder's agent, a record label, and a combination thereof.

33. The method of claim 9, wherein a portion of said fee is donated to one of the group consisting of a charity, a social cause, a political action group, and a combination thereof.

34. The method of claim 9, further comprising the step of providing access to merchandise by members of said audience, wherein said access is provided at said at least one venue.

35. The method of claim 34, wherein said access is via a kiosk

36. The method of claim 35, wherein said kiosk is an electronic kiosk.

37. The method of claim 36, wherein said electronic kiosk comprises a credit card swipable portal.

38. The method of claim 34, wherein said merchandise is a DVD, a CD, computer-readable files, an article of clothing, concert paraphernalia, or a combination thereof.

39. A method of distributing a performance to attendees, comprising:
(a) storing digitized data corresponding to said performance at a central facility;
(b) transmitting said digitized data from said central facility via a closed content distribution network to rendering equipment in at least one venue to provide access to said data in exchange for compensation; and
(c) providing compensation to a right holder in the performance.

40. The method of claim 39, wherein said at least one venue is a network subscriber.

41. The method of claim 39, wherein said at least one venue comprises a plurality of venues.

42. The method of claim 39, wherein said compensation is generated by tickets sold to attendees or a cover charge collected from attendees at said venue.

43. The method of claim 42, wherein said ticket sales take place through a venue, through a producing agent, through a third party, or a combination thereof.

44. The method of claim 42, wherein a portion of said fee is divided between said right holder, a producing agent and a licensing authority.

45. The method of claim 39, wherein said fee is a flat-rate paid by said venue.

46. The method of claim 39, wherein the venue contributes collected fees to total revenues based on the number of attendees at said rendered performance.

47. The method of claim 46, wherein said collected fees are based on ticket sales.

48. The method of claim 39, wherein said venue pays a fee for said rendering equipment.

49. The method of claim 48, wherein said fee for said rendering equipment is paid monthly.

50. The method of claim 39, wherein said transmission is via a method selected from the group consisting of the Internet, an intranet, an extranet, a telephony system, an Earth orbiting satellite system, a wireless communication system, a DVD, an optical disc, a CD, a computer-readable medium, and a combination thereof.

51. The method of claim 39, wherein said digitized data is modified at said central facility.

52. The method of claim 51, wherein said modification comprises the addition of information consisting of a brand, a watermark, and a combination thereof.

53. The method of claim 52, wherein said modification is the addition of images recorded at said at least one venue.

54. The method of claim 39, wherein said digitized data transmitted from said central facility is erased from said rendering equipment within 72 hours.

55. The method of claim 39, wherein said digitized data is stored at a site other than said rendering equipment.

56. The method of claim 55, wherein said stored digitized data is transmitted to at least one venue more than three hours after said performance.

57. The method of claim 39, wherein said digitized data is transmitted to said rendering equipment within three hours of said recording of said performance.

58. The method of claim 57, further comprising obtaining the right to resell said recording.

59. The method of claim 39, further comprising providing said at least one venue with promotional materials prior to said rendering.

60. The method of claim 59, wherein said promotional materials are provided by one of a group consisting of a producing agent, an event promoter, said right holder, said right holder's agent, a record label, and a combination thereof.

61. The method of claim 39, wherein a portion of said fee is donated to one of the group consisting of a charity, a social cause, a political action group, and a combination thereof.

62. The method of claim 39, further comprising the step of providing access to merchandise to said attendees, wherein said access is provided at said at least one venue.

63. The method of claim 62, wherein said access is via a kiosk.

64. The method of claim 63, wherein said kiosk is an electronic kiosk.

65. The method of claim 64, wherein said electronic kiosk comprises a credit card swipable portal.

66. The method of claim 63, wherein said kiosk is communicatively coupled to said closed content distribution network.

67. The method of claim 62, wherein said merchandise is a DVD, a CD, computer-readable files, an article of clothing, concert paraphernalia, or a combination thereof.

68. A business method, comprising distributing digitized data through a communication medium, wherein said communication medium comprises a central network connected to one or more remote venues for viewing said digitized data, and wherein said central network comprises one or more subservers which allow for electronic transfer of funds between at least two accounts; and wherein said digitized data comprises one or more recordings of live performances.

69. The method of claim 68, wherein said communication medium is the Internet, an intranet, an extranet, a telephony system, and Earth orbiting satellite system, a wireless communication system, or a combination thereof.

70. The method of claim 68, wherein at least one of said venues is selected from the venue group of a bar, a nightclub, a theater, a performance hall and a college campus.

71. The method of claim 68, wherein said funds are derived from ticket sales at said venue, ticket sales through a producing agent, ticket sales through a third party, or from a combination thereof.

72. The method of claim 68, wherein said funds are a flat-rate paid by said venue.

73. The method of claim 68, wherein said at least one venue contributes collected fees to total revenues based on the number of attendees at a rendered performance.

74. The method of claim 73, wherein a portion of said revenues is divided between a right holder, a producing agent and a licensing authority.
